(19) United States
(12) Patent Application Publication
(10) Pub. No.: US 2006/0242686 A1
(43) Pub. Date: Oct. 26, 2006

(54) Virus check device and system

(76) Inventors: Kenji Toda, Ibaraki (JP); Tetsuya Higuchi, Ibaraki (JP); Eiichi Takahashi, Ibaraki (JP); Masahiro Murakawa, Ibaraki (JP); Masaya Iwata, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 10/546,157

(22) PCT Filed: Feb. 20, 2004
(86) PCT No.: PCT/JP04/01978

§ 371 Date: Aug. 22, 2005

(30) Foreign Application Priority Data
Feb. 21, 2003 (JP) 2003-044081

(51) Int. Cl. H04L 9/32; G06F 17/30; G06F 15/16

(52) U.S. Cl. 726/3

(57) ABSTRACT

The present invention detects a computer virus at high speed from digital data acquired through a network using hardware in virus monitoring. With the invention, in an information processing terminal 002 capable of communicating with other information processing apparatus through a communication network 005, a virus checking apparatus 001 constructed of a hardware circuit is disposed in the side of an input channel of the network 005 and a virus is checked from input data from the network 005 by the virus checking apparatus 001. In order to change a virus pattern collated with the input data by hardware, the hardware circuit is detachably mounted or a rewritable logic device is used in the hardware circuit. The virus pattern of the logic device can be rewritten by sending virus definition information of a server 004 or control data generated based on this information to the virus checking apparatus 001.

### TECHNICAL FIELD

This invention relates to a virus checking apparatus and system for detecting harmful data called “a computer virus” or simply “a virus” at high speed from digital data acquired through a storage device or a communication network using hardware.

### RELATED ART

As computers connected to a communication network increase, the amount of data flowing through the communication network increases dramatically. In these data, “(computer) viruses” such as software for inhibiting an operation of a computer or information which a user or an administrator does not accept are included, so that the need to monitor data flowing through a channel of a network etc. and maintain computer resources or information, etc. from the viruses is increasing.

Monitoring of such viruses is conventionally performed using dedicated software in individual computers or a data-relaying network device etc., and is shown in, for example, Patent Reference 1.

[Patent Reference 1] JP-T-2001-508564

However, as a transfer rate of a channel of a network etc. improves, the amount of data flowing through the channel increases and because of speedup in such a channel, a processing speed of software cannot track in the near future and in virus monitoring software, it is expected that a CPU load of a personal computer will increase to cause a bottleneck.

On the other hand, hardware can operate at high speed as compared with software, and can monitor data of the channel at high speed with a delay reduced. However, generally, it is necessary to change a device in order to change data (virus check patterns) of a monitoring target inside hardware for virus checking and it is unsuitable for use for coping with monitoring target data varying every day.

### DISCLOSURE OF THE INVENTION

In view of such circumstances, an object of the invention is to provide a virus checking apparatus and system capable of detecting harmful data (virus) at high speed from digital data acquired through a network or a storage device by using hardware in virus monitoring.

According to a main characteristic of the invention, a virus checking apparatus [claim 1] comprising a hardware circuit (015) which is disposed in the side of an input channel of a communication network or a storage device and checks a virus from input data from the communication network or the storage device in an information processing terminal capable of communicating with other information processing apparatus through a communication network is provided. Incidentally, for convenience of understanding, parentheses are illustratively attached and represent corresponding numerals etc. in embodiments described below and are similar in the following description.

Also, according to another characteristic of the invention, a virus checking system [claim 8] comprising a server apparatus, an information processing terminal communicably connected to the server apparatus through a communication network, and a virus checking apparatus (001, 101) disposed in the side of an input channel of a communication network or a storage device of the information processing terminal, characterized in that the server apparatus comprises a virus definition file for updatably accumulating virus definition information and a control data (configuration data) sending part for sending control data generated based on the virus definition information, and the virus checking apparatus comprises a hardware circuit (015) for checking a virus from input data from a communication network or a storage device to the information processing terminal, and the hardware circuit has a control part (021) for updating a virus pattern collated with the input data based on control data from the server apparatus is provided.

The hardware circuit of the virus checking apparatus according to the invention can be configured to comprise a logic device having a data input part (030) for holding the input data, a virus definition part for holding a virus pattern and a pattern collation part (031) for collating the input data with the virus pattern [claims 4, 9].

The virus checking apparatus according to the invention can be configured to be inserted into a medium of the input channel [claim 2] or can be configured to be disposed in addition to an interface to a communication network of the information processing terminal [claim 3]. Also, the hardware circuit of the virus checking apparatus can be configured to be detachably mounted [claim 5]. Further, the hardware circuit can be configured to be rewritable by control data sent from other information processing apparatus through a communication network [claim 6] or can comprise a rewriting control part (021) for rewriting the logic device based on control data sent from other information processing apparatus through a communication network [claim 7].

[Action]

In a virus check according to the invention, in an information processing terminal (for example, a personal computer (PC) having a communication function) capable of communicating with other information processing apparatus through a communication network (for example, a LAN such as Ethernet (Ethernet, a registered trademark) or a wide area network such as Internet), invasion of a virus into the personal computer etc. can be detected in real time by collating data inputted from the communication network with virus feature data using hardware for virus check. That is, hardware can perform high-speed processing as compared with software and a virus check is made by the hardware inserted into the network or added to a network card (NIC, Network Interface Card) and thereby, harmful data, that is, a virus can be detected at high speed to take countermeasures such as elimination or blocking of invasion of the virus.

Also, with a problem that it is difficult to change a virus definition file in hardware, in the invention, in order to change a virus pattern collated with input data by the hardware, a hardware circuit is detachably mounted or a rewritable logic device is used in the hardware circuit. When a virus pattern of the logic device is rewritten, the virus pattern is updated by sending virus definition information of a server apparatus or control data generated based on this information to a virus checking apparatus.

Particularly, in the respect that the logic device is rewritably constructed, a rewritable logic device such as a programmable logic device (PLD) can be used in a virus definition and a collation part. For example, the PLD can easily make a change in a circuit and such a logic device is hardware, so that a high-speed operation can be maintained. Therefore, even when a communication network becomes faster and traffic increases, a virus check can be made at high speed without imposing a load on a CPU of a terminal personal computer.

Further, control data (configuration data) written into the rewritable logic device such as the PLD can be delivered from a server apparatus etc. through a communication network. For this purpose, a control part for updating the PLD could only be disposed by adding a small CPU such as PIC, a storage area such as Flash memory for temporarily accumulating control to the inside of a virus checking apparatus. Also, when the configuration data becomes large, a difference can be used or a data compression technique can be used.

Referring to a method for delivering control data (PLD configuration data) by the server apparatus, for example, when data has been accumulated in a buffer of an apparatus and communication becomes idle, a CPU (such as PIC) inside the apparatus stops a network. After the PLD is set in a rewriting mode and data is rewritten, a restart is made. When the control data has been accumulated in a buffer of a virus checking apparatus and communication becomes idle, a CPU (such as PIC) inside the apparatus stops a network. After the PLD is set in a rewriting mode and data is rewritten, a restart is made. Incidentally, it is preferable to utilize a secure mechanism of a digital signature or encryption, etc. when the control data is delivered to the terminal side.

A virus checking apparatus according to the invention can be inserted into a channel of a network. In the case of adapting a communication protocol, the apparatus can be inserted into all the channels (network, IDE cable, data bus, etc.). When the virus checking apparatus according to the invention is used as an external apparatus of a computer, supply of a power source is required, and a supply method is not limited and in addition to a method for supplying the power source from a normal commercial power source outlet, for example, the power source can also be supplied through a cable of Ethernet. Also, it can be incorporated into a network adapter of USB connection or can be incorporated into a network adapter of IEEE1394 connection.

Also, a virus checking apparatus can be built into a computer terminal. For example, the apparatus can be incorporated into an Ethernet adapter card (NIC) built into a computer. Similar fact applies to a PCMCIA card adapter for wireless LAN or a wireless LAN adapter built into the computer, etc.

In a virus checking system according to the invention, a virus definition is constructed in a hardware circuit for virus check in the side of a terminal apparatus such as a computer. In this case, the virus definition can also be embedded in a circuit constructed previously as a constant. Also, a virus definition file is placed on a server and subsequently, control data (PLD configuration data) can be generated using logic synthesis software for rewritable logic device (PLD). In a series of these generation processes, all the processes may be performed on the server, or the virus definition can also be delivered to an apparatus as it is, or implementation can also be performed so that processing of the intermediate stage is delivered to the terminal apparatus and the residual processing is performed on the terminal apparatus.

In a virus checking apparatus according to the invention, a virus definition is compared with data flowing through a channel using a logic circuit (logic device) as described specifically in an embodiment (FIGS. 3 and 4). In this case, data subjected to preprocessing (elimination excluding contents) is compared with the virus definition while passing through an input part (FIFO) of the logic circuit, and when the data does not coincide with the virus definition, the data passes as it is and when the data coincides (matches) with the virus definition, alarm information is outputted and necessary processing, for example, notification of a packet to a receiving destination or deletion of a packet can be performed properly.

According to the invention, since it is constructed so that digital data passing through a channel etc. is collated at high speed by a virus checking hardware (virus checker) as described above, it is very useful for a system for performing data transfer of high speed particularly exceeding 1 Gbps.

### BRIEF DESCRIPTION OF THE DRAWINGS

FIG. 1 is a diagram representing a configuration example of the whole virus checking system according to one embodiment of the invention.

FIG. 2 is a diagram representing one configuration example [1] of a virus checking apparatus (virus checker) according to one embodiment of the invention.

FIG. 3 is a diagram representing one configuration example of a virus collator in the virus checking apparatus according to one embodiment of the invention.

FIG. 4 is a diagram representing one configuration example of a byte match detector in the virus checking apparatus according to one embodiment of the invention.

FIG. 5 is a diagram representing another configuration example [2] of a virus collator in the virus checking apparatus according to one embodiment of the invention.

FIG. 6 is a diagram representing another configuration example [3] of a virus collator in the virus checking apparatus according to one embodiment of the invention.

FIG. 7 is a diagram representing one configuration example of a virus check pattern rewriting device according to one embodiment of the invention.

FIG. 8 is a diagram showing one configuration example of a two-way virus checking apparatus (two-way virus checker) according to one embodiment of the invention.

FIG. 9 is a diagram representing a configuration example of incorporating a virus check pattern rewriting device into a virus checker according to one embodiment of the invention.

FIG. 10 is a diagram representing another configuration example of a virus check pattern rewriting apparatus according to one embodiment of the invention.

FIG. 11 is a diagram representing a virus check pattern rewriting configuration example by a PC terminal according to one embodiment of the invention.

FIG. 12 is a diagram representing a generation process example of a virus check pattern according to one embodiment of the invention.

FIG. 13 is a diagram representing a generation process example of a compressed virus check pattern according to one embodiment of the invention.

FIG. 14 is a diagram representing a rewriting flow of a virus check pattern according to one embodiment of the invention.

FIG. 15 is a diagram representing a configuration example of the whole virus checking system according to another embodiment of the invention different from the example shown in FIG. 1.

FIG. 16 is a diagram showing details of the virus checker shown in FIG. 15 and is a diagram showing one example of applying a schematic diagram of a LAN shown in FIG. 2 to a storage device.

FIG. 17 is a diagram showing details of a controller.

FIG. 18 is a diagram showing an example of being mounted into a USB controller.

### BEST MODE FOR CARRYING OUT THE INVENTION

Preferred embodiments of the invention will be described below in detail with reference to the drawings. Incidentally, in each of the drawings, description of elements which are not directly related to the subject matter of the invention even when it is necessary for operation of a circuit, for example, an element related to supply of a power source is omitted.

[Whole Configuration of System]

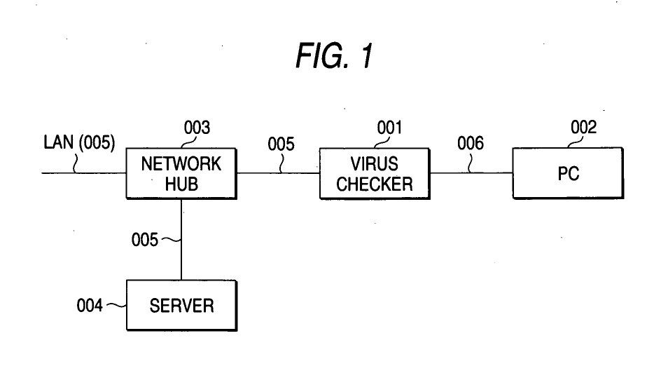

FIG. 1 schematically shows the whole configuration of a virus checking system according to one embodiment of the invention. In a computer (numeral 002 in the drawing) which is a body apparatus, a hardware apparatus for virus checking (an apparatus of the invention, numeral 001 in the drawing) is inserted into the channel side of input to a communication network (numeral 005 in the drawing) and this hardware apparatus is called “a virus checker” in the present description. Even when a communication network (numeral 006 in the drawing) for connecting the virus checker 001 to the computer 002 is a medium equal to or a medium different from the communication network 005, the communication network has no influence on a function of the invention, and a wire network such as Ethernet (Ethernet, a registered trademark) or a wireless network such as a wireless LAN can be applied to the communication network. For example, there is the case where numeral 005 is 100BASE-TX and numeral 006 is 10BASE-T. The computer 002 may be any of a workstation, a Macintosh computer, a computer cluster, a large scale computer, a PDA (Personal Digital Assistant), etc. in addition to a personal computer (a PC, a personal computer) as long as the computer 002 is a calculating machine or the like connected to the communication network. This virus checker can detect or block invasion of a virus into a computer etc. in real time by collating data inputted from the communication network with virus feature data (virus pattern). Also, a collation function device and the virus pattern of the virus checker can be constructed of a PLD (Programmable Logic Device) or an FPGA (Field Programmable Gate Array) and in this case, when necessary, the latest virus pattern is received from a server (numeral 004 in the drawing) on the communication network and reconfiguration can be performed using that virus pattern. The server 004 may be any of a personal computer or a workstation, etc. as long as the server 004 is a member which is connected to the Internet and has the capability of delivering data to other computers. Also, the server 004 maybe directly connected to the virus checker 001, and may be connected through a network hub (numeral 003 in the drawing) having a function of relaying communication data as shown in FIG. 1, and also may be connected by a device or the like having a function of connecting other relays or LANs (Local Area Network) each other.

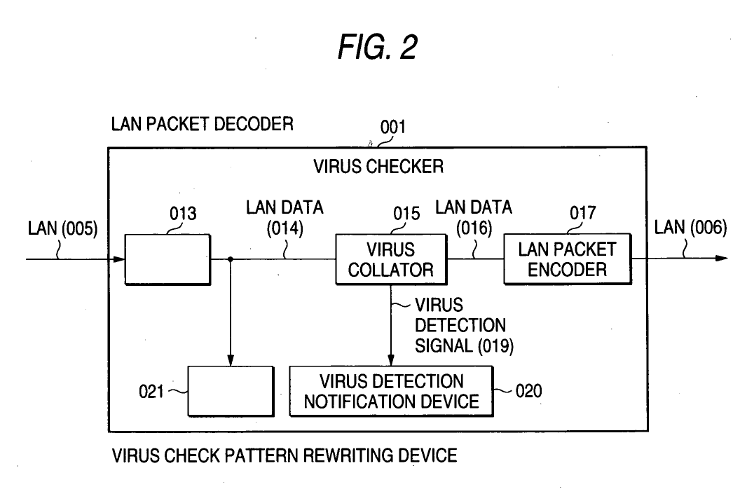

FIG. 2 is a diagram schematically showing one example of connecting the virus checker 001 to a one-way communication network. In FIG. 2, numeral 005 is a communication network (data input path from the outside) into which data flows, and numeral 006 is a communication network of the side of the computer 002. Numeral 013 is a processing circuit for converting an electrical signal on the communication network into digital data with a width of one byte (eight bits), and numeral 014 is wiring for guiding network data with a byte width, and numeral 015 is a virus collator for comparing and collating byte data at high speed, and numeral 016 is wiring for guiding byte data from which virus data is eliminated, and numeral 017 is a processing circuit for converting the byte data into an electrical signal on the communication network. The virus collator 015 is implemented using a reconfigurable device. For example, CPLD, FPGA, etc. which are products of Altera Inc., Xilinx Inc., etc. are used. Another output signal 019 of the virus collator 015 is a signal indicating that a virus is detected, and is inputted to a virus detection notification device 020 for notifying a computer or a user of detection of the virus. The virus detection signal 019 informs the virus detection notification device 020 of the virus detection and a kind of the detected virus. The virus detection notification device 020 can mount various functions required by the computer 002, for example, a function of displaying information about the detected virus by an LED etc. and notifying a user of the information, a function of blocking an output of virus-detected network data to numeral 006, a function of notifying the computer 002 of information about the detected virus, etc. In FIG. 2, numeral 021 is a virus pattern rewriting device, and records a virus pattern of the latest version supplied via a LAN and performs an operation for updating the virus collator.

All the network data moving toward the computer 002 on the communication network 005 is converted into byte data by the processing circuit 013 and is guided to the virus collator 015. In the virus collator 015, the guided network data is preprocessed or as it is and is monitored at high speed by a collation circuit constructed in the inside and is compared with the pattern and its determination result is outputted in a proper form according to use as the virus detection signal 019.

By using a reconfigurable logic device (PLD, FPGA, etc.) in implementing the virus collator 015, when a change occurs in a virus pattern, it can cope with the change by reconfiguring the virus collator 015 into a circuit based on the latest virus pattern. Also, a circuit of this virus collator 015 is hardware, so that a high-speed comparison can be made and network data can be monitored without causing a long delay in network data communication and further imposing a load on the computer 002.

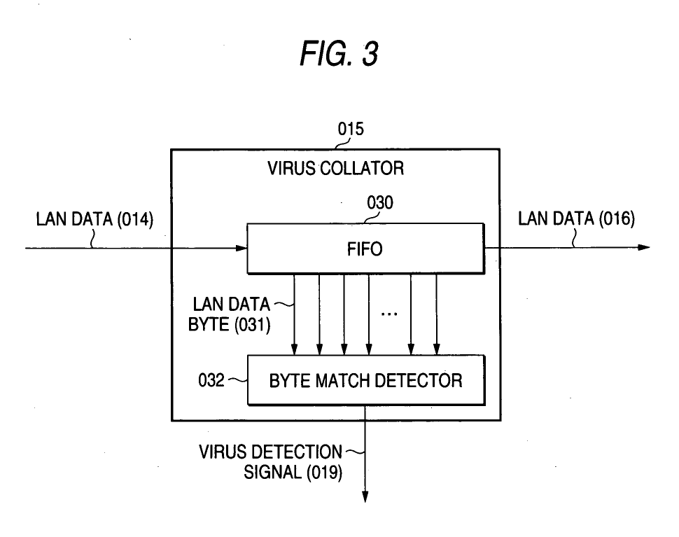

The inside of the virus collator 015 can be implemented as shown in FIG. 3. In the drawing, numeral 030 is FIFO for receiving network data 014 and holding byte data with a length longer than or equal to a length of a virus pattern, and network byte data 031 held in the FIFO is outputted to a byte match collator 032 in a byte unit, and numeral 032 makes collation with a virus pattern in the byte unit. The byte match collator 032 always continues to collate the inputted network byte data 031 with the virus pattern, and can output the virus detection signal 019 at the moment when a match is detected. When numeral 015 is constructed of the reconfigurable device, the FIFO portion with a fixed configuration can be included or not included in the reconfigurable device.

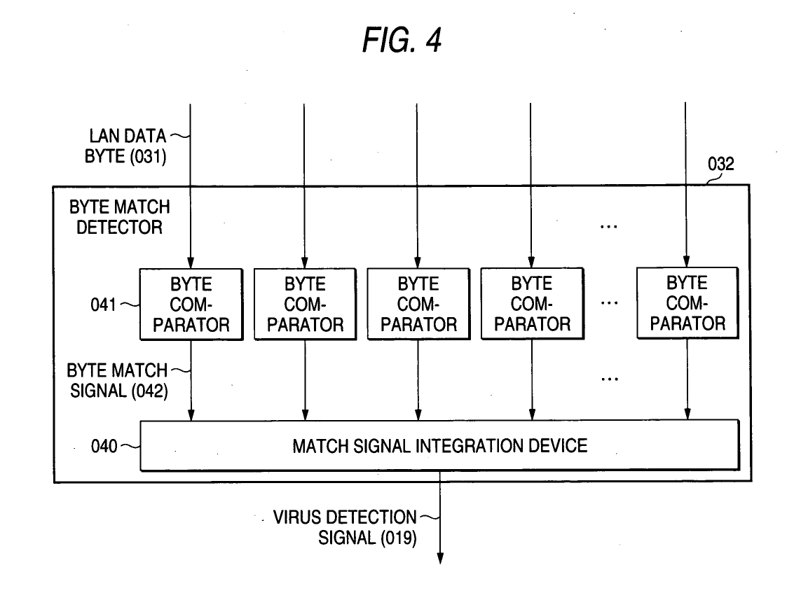

A circuit configuration, which makes collation with one virus pattern, of the byte match detector 032 is shown in FIG. 4. In the drawing, numeral 041 is a byte comparator and compares network data with a virus pattern in a unit of one byte. A string of the byte comparators 041 are implemented and ranged as a constant comparison circuit along a list of data constructing the virus pattern, so that the case of matching all the byte match signals 042 which are output signals of the byte comparators indicates that a virus is included in data inputted from the network. A match signal integration device 040 is a circuit for generating the virus detection signal 019 in the case of indicating that all the byte match signals are matched.

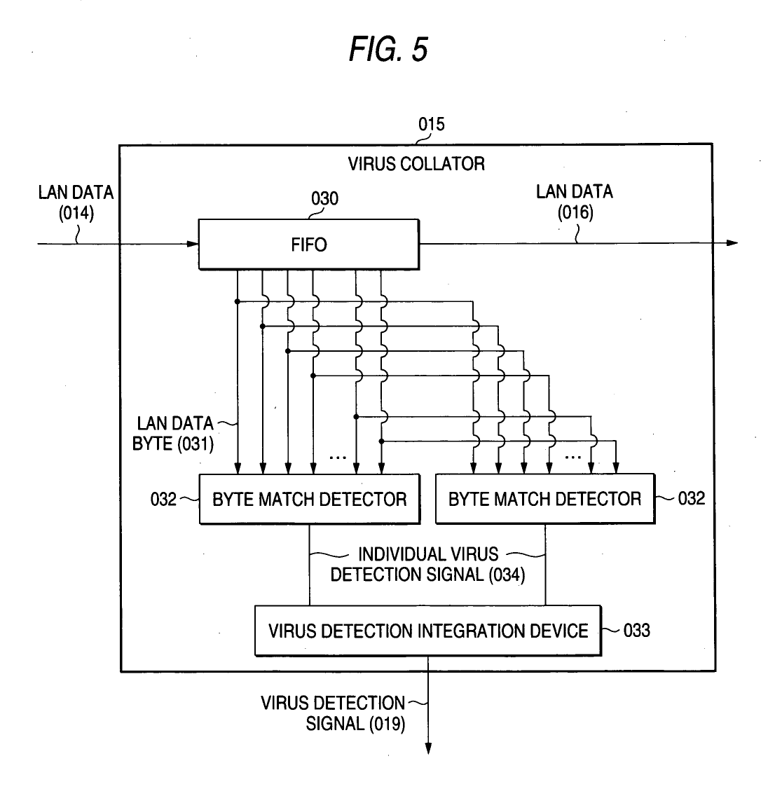

The virus collator 015 of FIG. 3 is an example of implementing a collation with one virus pattern, but by extending this configuration, collations with plural virus patterns simultaneously can be performed. FIG. 5 shows one of extension methods of FIG. 3. This is a method for distributing outputs of FIFO to plural byte match detectors 032 and simultaneously making collations with different virus patterns. The configuration of FIG. 4 can be used in the byte match detector 032 and the respective byte match detectors 032 make collations with different virus patterns. In this configuration, a virus detection integration device 033 is used in order to generate one virus detection signal 019 from outputs of the plural byte match detectors 032. This is a circuit for generating a virus detection signal 019 which is a signal indicating detection of a virus and a kind of the detected virus when an individual virus signal 034 is outputted from any one of the plural byte match detectors 032.

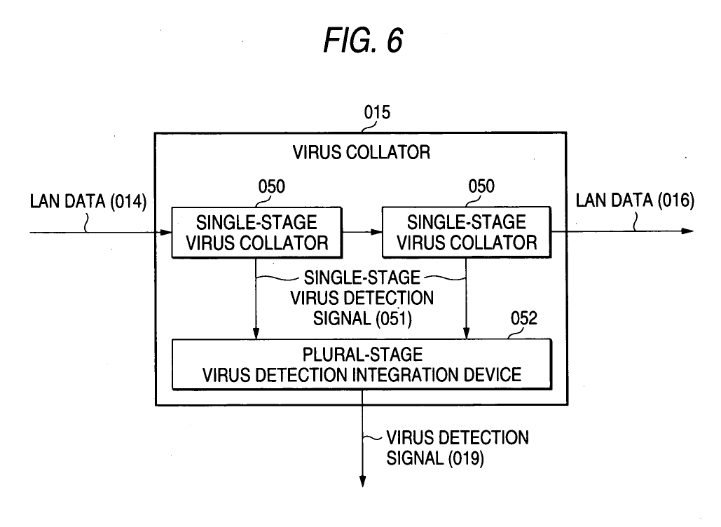

Also, the virus collator 015 of FIG. 3 can be extended as shown in FIG. 6. In FIG. 6, the virus collator 015 of FIG. 3, that is, a single-stage virus collator 050 is included as its part. Then, as shown in the drawing, the single-stage virus collators 050 are connected in cascade form and plural virus patterns can be compared sequentially. Also, in this case, a plural-stage virus detection integration device 052 is used in order to integrate plural virus detection signals in a manner similar to the configuration of FIG. 5. This plural-stage virus detection integration device also has the same function as that of the virus detection integration device of FIG. 5, and is a circuit for generating a virus detection signal 019 which is a signal indicating detection of a virus and a kind of the detected virus when a single-stage virus signal 051 is outputted from any one of the plural virus collators 050.

Incidentally, the method of FIG. 5 and the method of FIG. 6 may simultaneously be applied to the virus collator 015 of FIG. 3 for extension.

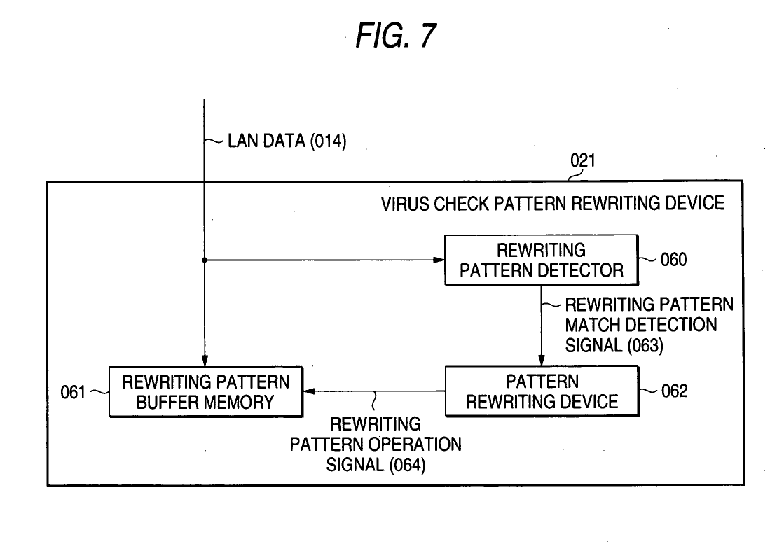

An implementation example of the virus pattern rewriting device 021 is shown in FIG. 7. In this example, a rewriting pattern detector 060 always monitors a network data byte 014 and when a data string having a mark indicating update data of a virus pattern is detected, a rewriting pattern match detection signal 063 is generated and a pattern rewriting device 062 is started. A hardware configuration identical to that of the virus collator 015 of FIG. 3 can also be used in implementation of the rewriting pattern detector 060 and also another configuration having an equal function can be used. Rewriting pattern buffer memory 061 has a function of always holding the latest data with a certain length among data byte strings flowing through the network data byte 014. A length of the data byte held by the rewriting pattern buffer memory 061 is set at a value longer than the maximum value of a rewriting pattern length. The pattern rewriting device 062 started by the rewriting pattern match detection signal 063 stops data updating of the rewriting pattern buffer memory 061 through a rewriting pattern operation signal 064 and subsequently stops an operation of the virus collator 015. Next, the pattern rewriting device 062 updates a reconfigurable device used in the inside of the virus collator 015 using a virus pattern for updating held in the rewriting pattern buffer memory 061. In updating methods etc., a proper method is used for every reconfigurable device used in implementation. After the updating is ended, an operation of the rewriting pattern buffer memory 061 is resumed and subsequently an operation of the virus collator 015 is also resumed.

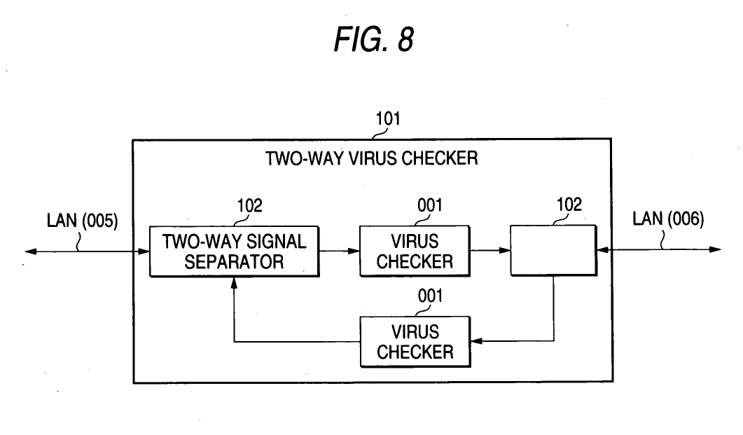

In the virus checker of FIG. 2, the example of the case of communicating data in one way through the communication network has been shown, but the case of being extended for a two-way data channel in a form of a normal communication network using this mounting is shown in FIG. 8. In the drawing, numeral 001 is a virus checker as shown in FIG. 2, and communication networks 005 and 006 are two-way networks. Communication network data inputted to a two-way virus checker 101 is separated into flows of signals by one way by a two-way signal separator 102 and is again integrated into a two-way signal by a two-way signal separator 102 after passing through the virus checkers. The two-way signal separator 102 can be implemented using a circuit called a hybrid used in a network input part of an NIC (Network Interface Card) for Ethernet.

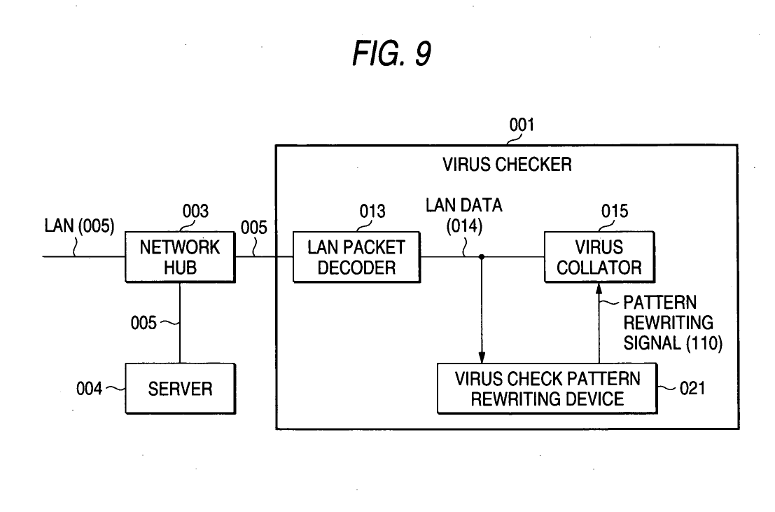

Pattern rewriting of a virus collator 015 will be described using FIG. 9. First, a server 004 present on the Internet or connected to a communication network 005 through a network hub 003 etc. outputs virus pattern updating data having a particular mark to the communication network 005 in some method so as to be inputted to a virus checker 001. For example, the output can also be produced in a communication method such as broadcast if possible, or a method of producing an output as communication data to a computer 002 into which the virus checker 001 is inserted in the input side. In the inside of the virus checker 001, communication network data is inputted to the virus collator 015 or a virus pattern rewriting device 021 as a network data byte 014, and when the virus pattern rewriting device 021 recognizes network data having a mark of the virus pattern updating data, as described in the previous section, the virus pattern updating data is fetched and a function of the virus collator is stopped and using a pattern rewriting signal 110, the virus collator 015 is reconfigured and thereafter the virus collator is restarted.

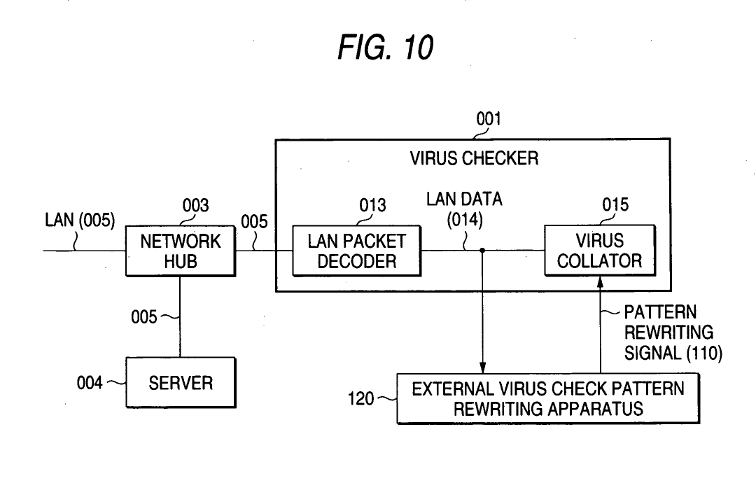

In FIG. 9, the virus pattern rewriting device 021 is incorporated into the inside of the virus checker 001, but as shown in FIG. 10, an external virus pattern rewriting apparatus 120 can also be implemented in the outside of the virus checker 001. In the case of this configuration, a virus pattern can also be updated automatically by setting the external virus pattern rewriting apparatus 120 in a state of being always connected to the virus checker 001, but a rewriting operation can also be performed by hand of a user by connecting the external virus pattern rewriting apparatus 120 to the virus checker 001 only when it becomes necessary to perform updating.

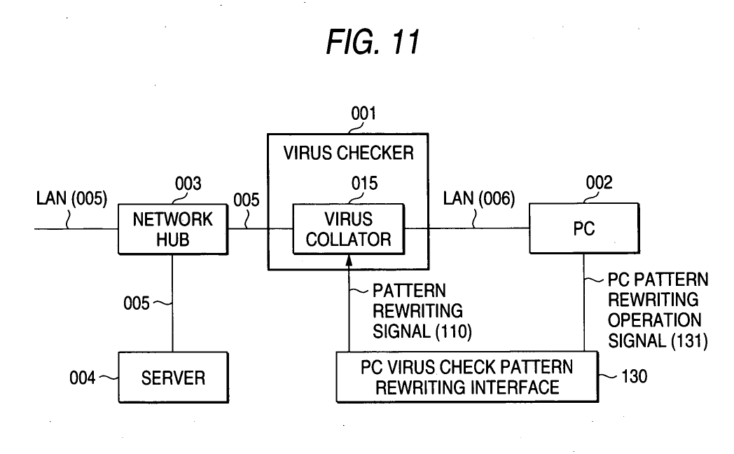

Further, as shown in FIG. 11, a virus pattern rewriting function is arranged in the outside and is connected to a computer 002 using a communication network 006 or by a medium different from the communication network 006 and a virus pattern can also be rewritten using software on the computer 002. In the case of this configuration, a virus checker 001 operates independently of the computer 002 at the time of normal operation, and when virus pattern updating data arrives at the computer 002, the computer 002 stops an operation of the virus checker 001 and rewrites and restarts a virus collator 015 through a PC virus checker pattern rewriting interface 130 and thereby, updating of the virus pattern can also be implemented. Also, in the case of this configuration, a server 004 can also send the virus pattern updating data to the computer 002, or the computer 002 can also check the presence of the virus pattern updating data to the server 004 actively or periodically. Also, both can be used together, or updating can be checked or operated by instructions of a user. Further, a reconfigurable device configuring the virus collator 015 is detached from this apparatus and using a commercially available writing apparatus, data of the inside of the computer 002 is written into this reconfigurable device and thereby, updating of the virus pattern can also be implemented.

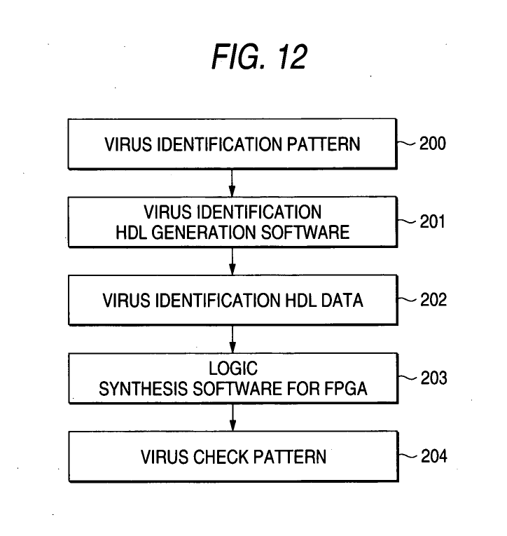

The virus pattern used by the virus checker 001 may be a data string indicating a feature of a virus body as it is or may adopt a form of data for reconfiguring the virus collator 015. Data for reconfiguration of this PLD etc. is called configuration data etc. and can also be generated as shown in FIG. 12. In the drawing, numeral 200 is the as-is data of a data byte string indicating a feature of a virus. Using this raw data 200 which is a constant byte string, a part or all of the virus collator described by an HDL (Hardware Description Language) for generating hardware for making a comparison with a constant is generated. An output is virus identification HDL data 202. More specifically, virus identification HDL generation software 201 performs processing for writing data of a raw virus pattern which is a constant value of comparison into an HDL file of a template in which a frame of a circuit is described. This virus identification HDL data 202 is converted into the final virus pattern 204 using a program called logic synthesis software for FPGA capable of generating configuration data for a reconfigurable device used in implementation of the virus collator 015 actually from the HDL file.

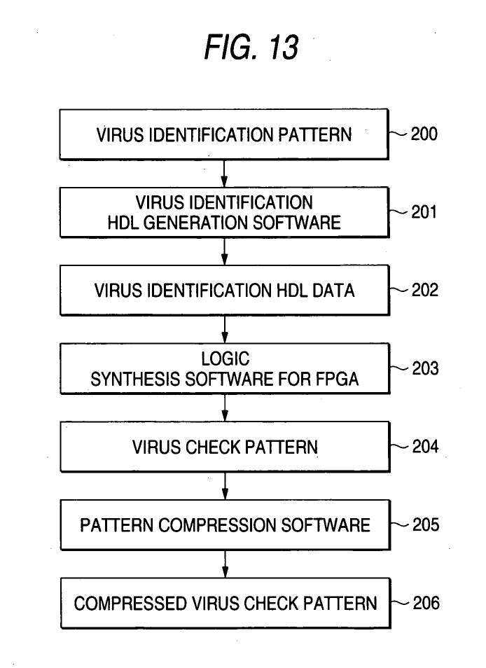

When a size of the virus pattern 204 becomes large, as shown in FIG. 13, using some compression software 205, data may further be compressed to send a compressed virus pattern 206 to a virus checker. At this time, when a pattern rewriting device 021 is built into a virus checker 001, the pattern rewriting device 021 may generate the original virus pattern 204 from the compressed virus pattern 206, and also when a computer 002 updates a virus pattern, software on the computer 002 may generate the original virus pattern 204 from the compressed virus pattern 206. As algorithm used in this compression, various data compression methods used generally may be used and also a method for sending only a difference from a virus pattern of the previous version or a method for further subjecting a difference to data compression and sending the difference may be used.

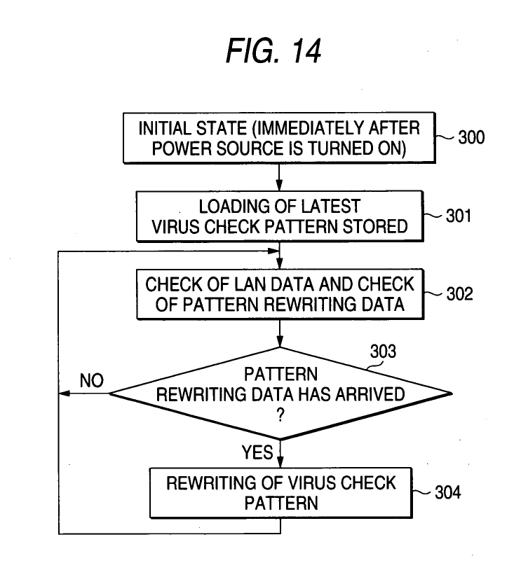

An operation step of the present system including updating of a virus pattern is shown in FIG. 14. A state 300 is an initial state and immediately after a power source is turned on, operations such as initialization necessary as an apparatus are performed and after their operations are ended, the step proceeds to the next state 301 automatically. In the state 301, data of the latest virus pattern stored inside the virus checker 001 is loaded into a reconfigurable device of the inside of the virus collator 015 and if possible, a function check etc. are made and the step proceeds to the next state 302. The state 302 is a normal operation state, and data on a communication network is monitored while a check of virus pattern updating data is made. In a subsequent decision 303, it is checked whether or not the virus pattern updating data has arrived, and when it has arrived, the step proceeds to a state 304 and when it has not arrived, the step proceeds to the state 302. When the virus pattern updating data has arrived, in the state 304, updating processing of the virus pattern is performed and the arriving updating data is recorded as the latest virus pattern data and if necessary, initialization is performed and if possible, a function check etc. are further made and the step proceeds to the state 302. In the present system, the processing is ended by turning off the power source without performing special processing in the case of the end.

An installation method for incorporating the virus checker of the invention into an NIC (Network Interface Card) built into a computer, a mother board in which a main element of the computer is implemented, or a device such as a switching hub and a router, which are network devices, is also useful. Also, an installation method for inserting the virus checker into the middle of each of the networks or the like implemented inside the computer is useful.

A detachable storage device in addition to a network is considered as a path of invasion of a virus into a computer. There is a possibility that a virus-affected file gets held in the inside of its storage by connecting such a storage device to a virus-affected computer.

By adapting to a communication protocol, the virus checking apparatus according to the invention can also be inserted into a channel to any storage device to which a computer can obtain access. Incorporation methods or power source supply conditions in this case are similar to those of the case of being inserted into a channel of a network and further, the virus checking apparatus can also be incorporated into a body of the storage device. In control data written in to a rewritable logic device such as a PLD in this case, rewriting of a virus pattern can be performed using software on a computer inside a computer terminal and further, rewriting can also be performed by connecting a storage device for rewriting or a network to a body of the virus checking apparatus.

By inserting this apparatus between the computer terminal and the storage device, execution of a program or data transfer can be performed without imposing a load by a virus check on a CPU.

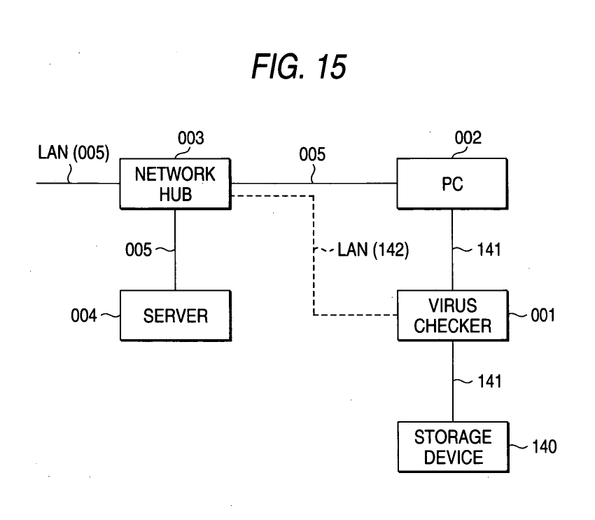

In FIG. 15, a virus checker 001 is inserted into a cable 141 of connection between a storage device 140 and a computer 002 which is a body apparatus. Even when a connection cable for connecting the virus checker 001 to the computer 002 is any medium, the connection cable has no influence on a function of the invention, and a wire network such as USB, IEEE1394, serial, parallel, SCSI, IDE, Ethernet or a wireless network such as a wireless LAN can also be applied. Also, this storage device may be directly connected to the virus checker 001 or may be connected through a relay hub on the way to the connection cable.

The virus checker collates data passing through the cable with a virus pattern and thereby, invasion of a virus from the storage device to the computer etc. or invasion of a virus from the computer etc. to the storage device can be detected or blocked in real time.

When necessary, the virus checker can receive the latest virus pattern from a server 004 on a communication network by utilizing software on the computer 002 or by through a LAN cable 142 directly, and can be reconfigured using the virus pattern.

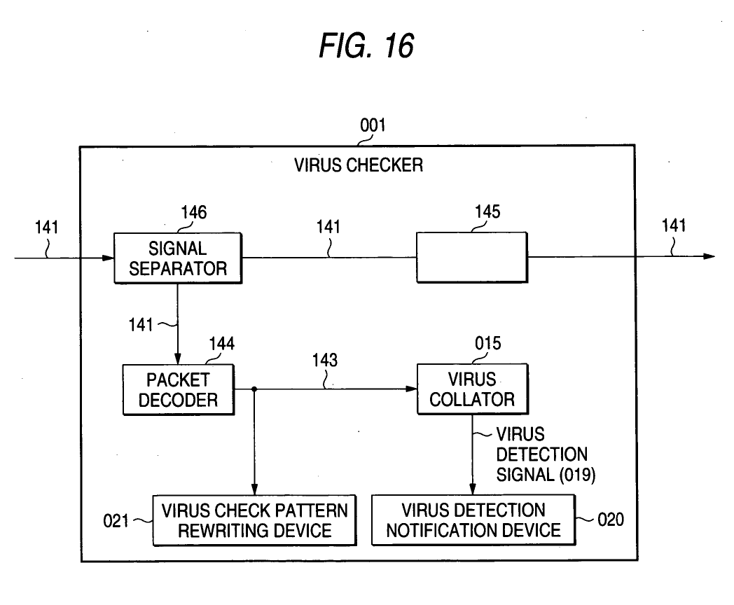

FIG. 16 is a diagram showing one example of applying a schematic diagram of a LAN shown in FIG. 2 to a storage device. The encoder of numeral 017 shown in FIG. 2 is eliminated, but in this example, application using the encoder can also be performed and vice versa, application as shown in FIG. 16 in which the encoder is eliminated from FIG. 2 can naturally be performed.

In FIG. 16, numeral 146 is a circuit for separating data flowing through numeral 141. Processing for encoding data decoded by a decoder 144 once and returning the data to a channel can be omitted by inserting a circuit 145 for causing a delay while the data is separated and virus collation of a buffer etc. is ended. The circuit 145 can also be omitted in the case of a sufficiently high-speed virus check.

An installation method for inserting the virus checker of the invention into various data transmission channels built into a computer is also useful. Also, a method for installing the virus checker into an I/O unit of a storage device body is useful.

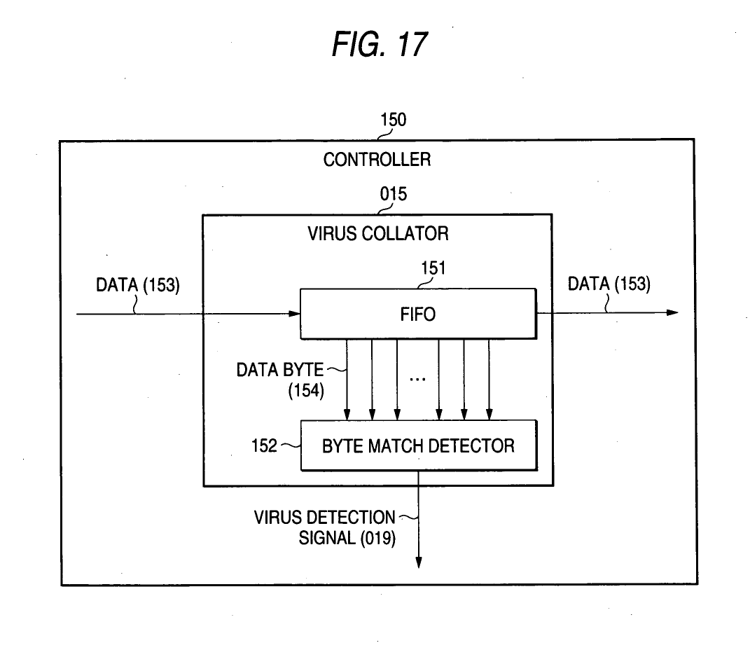

In the case of applying the virus checker of the invention to an external storage body of a personal computer, a method for being built into a controller for controlling data communication of USB, IEEE1394, etc. is also useful. As shown in FIG. 17, the controller is provided with a buffer 151 of FIFO etc. for temporarily holding data, and data 153 is outputted from the buffer 151 to a byte match detector 152 as a data byte 154 and a virus pattern is collated. When the buffer built into the controller does not have sufficient size to correspond to the virus pattern, it can be applied by disposing a buffer separately. A virus collator has been described in FIG. 3.

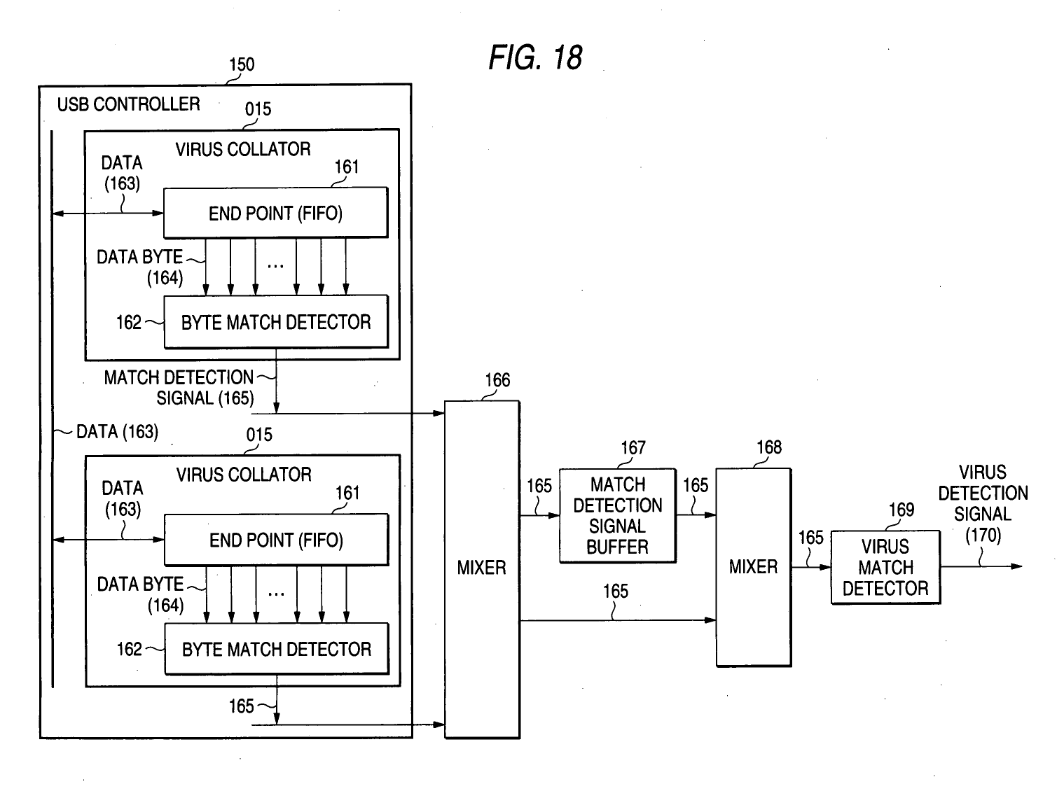

An example of implementation into a USB controller is shown in FIG. 18. In the USB controller, data is temporarily buffered by FIFO called an end point 161. Also, as shown in FIG. 17, a virus collator can be constructed by installing a byte match detector 162 in this position. When the end point 161 is singly used, it may be unnecessary to use a mixer 166 and for partial matching with a virus pattern, a match detection signal 165 is held in a buffer 167 and is matched with the next match detection signal by a mixer 168 and detection is performed by a virus match detector 169 and a virus detection signal 170 is outputted. Plural end points 161 can also be used collectively. In that case, the match detection signals 165 from the byte match detectors 162 of the end points 161 of a group are collected through the mixer 166 and are sent to the match detection signal buffer 167 and the mixer 168. In FIG. 18, numerals 166 to 169 are placed in the outside of the USB controller 150, but are not necessarily placed in the outside and any of the numerals 166 to 169 may be taken in the USB controller and the back portions from the byte match detector 162 can also be placed in the outside of the controller.

The implementation example of the storage of USB connection has been shown in FIG. 18, but can similarly be applied to storages with interfaces of IEEE1394 or SCSI, etc. used in similar uses.

Of course, the virus checker of the invention can be inserted into any positions where it is capable of identification of data of a collation target in addition to use of the buffer built into the controller.

Further, an anti-virus tool implemented in software currently has functions such as elimination or blocking of invasion in addition to detection of a virus, but any of their functions are processing performed after detection and by applying the present idea to a detection part, high efficiency and speedup of processing can be achieved. Conversely, by adding functions of a virus invasion blocking part or a virus elimination part, etc. to the present detection part, an apparatus functionally identical to the current anti-virus tool can be constructed.

The description has been made above based on the illustration examples, but the invention is not limited to the examples described above and also includes other configurations capable of being easily modified by those skilled in the art within the scope described in the claims.

As described above, according to the invention, it is constructed so that data inputted from a communication network is collated with virus feature data using hardware for virus check inserted into a communication network channel or added to a network card etc., so that by making use of a hardware advantage that high-speed processing can be performed as compared with software, invasion of harmful data, that is, a virus into a personal computer etc. can be detected in real time and the virus can be detected at high speed to take countermeasures such as elimination or blocking of the invasion.

1. A virus checking apparatus comprising:
a hardware circuit which is disposed in the side of an input channel of a communication network or a storage device and checks a virus from input data from the communication network or the storage device in an information processing terminal capable of communicating with other information processing apparatus through a communication network.

2. The virus checking apparatus as claimed in claim 1, which is inserted into a medium of the input channel.

3. The virus checking apparatus as claimed in claim 1, which is disposed in addition to an interface to a communication network of the information processing terminal.

4. The virus checking apparatus as in claim 1 wherein
the hardware circuit includes:
a logic device having a data input part for holding the input data,
a virus definition part for holding a virus pattern, and
a pattern collation part for collating the input data with the virus pattern.

5. The virus checking apparatus as in claim 1, wherein
the hardware circuit is detachably mounted.

6. The virus checking apparatus as in claim 1, wherein
the hardware circuit is rewritable by control data sent from other information processing apparatus through a communication network.

7. The virus checking apparatus as claimed in claim 4, wherein
the hardware circuit further includes:
a rewriting control part for rewriting the logic device based on control data sent from other information processing apparatus through a communication network.

8. A virus checking system comprising:
a server apparatus,
an information processing terminal communicably connected to the server apparatus through a communication network, and
a virus checking apparatus disposed in the side of an input channel of a communication network or a storage device of the information processing terminal, wherein
the server apparatus includes:
a virus definition file for updatably accumulating virus definition information, and
a control data sending part for sending control data generated based on the virus definition information, and
the virus checking apparatus includes:
a hardware circuit for checking a virus from input data from a communication network or a storage device to the information processing terminal, and
the hardware circuit has a control part for updating a virus pattern collated with the input data based on control data from the server apparatus.

9. The virus checking system as claimed in claim 8, wherein the hardware circuit further includes:
a logic device having a data input part for holding the input data,
a virus definition part for holding the virus pattern, and
a pattern collation part for collating the input data with the virus pattern.
